(19) United States
(12) Patent Application Publication
(10) Pub. No.: US 2024/0349695 A1
(43) Pub. Date: Oct. 24, 2024

(54) PET FEEDING SYSTEM

(71) Applicant: Jeff Sutton, Isle of Palms, SC (US)

(72) Inventor: Jeff Sutton, Isle of Palms, SC (US)

(21) Appl. No.: 18/638,103

(22) Filed: Apr. 17, 2024

Related U.S. Application Data
(60) Provisional application No. 63/460,046, filed on Apr. 18, 2023.

(51) Int. Cl. A01K 5/02; A01K 15/02

(52) U.S. Cl. CPC A01K 5/0233; A01K 5/0291; A01K 15/021

(57) ABSTRACT

An animal feeding device that dispenses food to a domesticated animal, such as a pet. Food is used to motivate the domesticated animal, such as a dog, to move to a target. A target, such as a pad positioned on the floor, is actuated by an activity of the domesticated animal. Upon actuation of the target a dispenser dispenses food. The domesticated animal learns that actuating the target will reward the domesticated animal by providing food to the domesticated animal. By dispensing a small amount of food, the domesticated animal will repeat the process several times over the course of a day, providing exercise to the domesticated animal. The use of multiple remote dispensers, with only one of the remote dispensers actuated, causes the domesticated animal to search for the dispenser that dispensed food, increasing the amount of exercise for the domesticated animal.

### BACKGROUND OF THE INVENTION

Pets may tend to be sedentary when they are not stimulated. This is particularly true of pets that are left alone for long periods of time with no human interaction. Domesticated animals inhabiting the indoors or enclosed spaces may tend to sleep or rest for long periods of time without exercise due to the absence of stimulation.

Pets, and particularly dogs, will respond to obtaining food or treats. The animals will undertake physical effort to obtain treats or other small bits of food. There is a need for an interactive device that will motivate domesticated animals to move and exercise in the absence of human or other stimulation

### SUMMARY OF THE INVENTION

The present invention is a device that is actuated by a domesticated animal, such as a pet. Actuation of the device dispenses food to the animal. Food is used to motivate the animal, such as a dog, to move to a target. Upon actuation of the target by the animal, the device dispenses food. The domesticated animal learns that actuating the target will reward the animal by providing food to the animal.

Upon sensing actuation of the target, the device transmits a signal to a remote food dispenser. The food dispenser responds to the signal by dispensing a small amount of food, such as a dog treat, into a trough or receptacle. The animal learns that actuating the target, such as by stepping on the target, device provides food to the animal. By dispensing a small amount of food, the animal will repeat the process several times over the course of a day providing exercise to the animal. The use of multiple remote dispensers, with only one of the remote dispensers actuated, causes the animal to search for the dispenser that dispensed food, increasing the amount of exercise for the animal.

### BRIEF DRAWING DESCRIPTION

FIG. 1 is a perspective view of a food dispenser and actuator target.

FIG. 2 is a perspective view of the food dispenser of FIG. 1.

FIG. 3 is an example of an actuator target shown as a top plan view.

FIG. 4 demonstrates the use of multiple food dispensers, each positioned remotely from other food dispensers and the actuator target.

### DESCRIPTION OF PREFERRED EMBODIMENTS

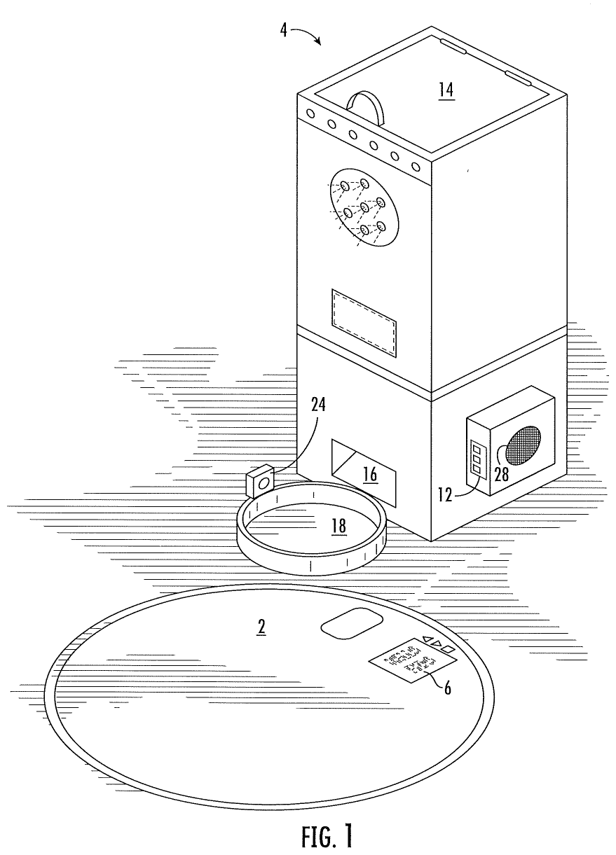

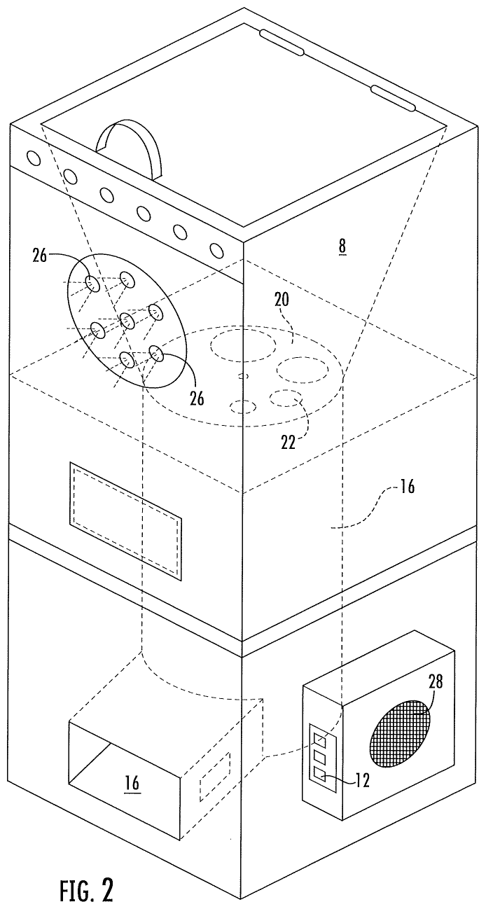

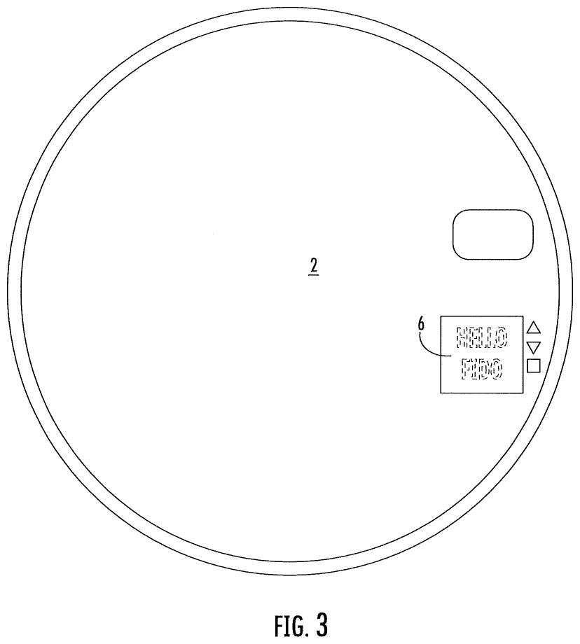

An actuator target 2 may be a pad that is placed on a floor of a room in a house, an apartment, an office or other building. FIGS. 1, 2, 3. When actuated, the pad provides a short range (near field) wireless communication signal to one or more food dispensers 4. Communication may be by Bluetooth, Wi-Fi or similar near field communication devices. In one embodiment, the pad is compressible under a domesticated animal's weight when the animal steps on the pad with one or more of its feet, with pressure from the animal's weight causing contacts or a sensor to actuate the signal that is transmitted from the actuator target to the food dispenser. Weight actuation such as used in electronic scales may be employed. A pad that senses an increase in heat due to the presence of the domesticated animal's body temperature may be utilized in another embodiment. The food dispenser comprises a receiver 12 that receives a signal from a transmitter of the target, initiating actuation of the food dispenser.

The actuator target 2 includes a processor 6 that sends the communication signal to one or more of the food dispensers 4. The processor may send the signal to only one of a plurality of food dispensers, with the processor sending the signal to each food dispenser in a rotation, or the processor may send the signal chosen randomly to one of the plurality of food dispensers. Upon an animal stepping on the actuator target, the communication signal is transmitted by the target to the selected food dispenser, which dispenses food from a reservoir in the food dispenser.

The food dispenser 4 comprises a reservoir 8 that holds a food supply. For example, the food may be dry food or dry treats. The food or treats are solids, and are formed in small bits as is typical of dry dog food, which is referred to herein as granular animal food. The reservoir may be located in an upper portion of the food dispenser, with a door 14 to the dispenser provided for supplying the reservoir with food. The food is suitable for the subject animal. For example, dog food is used with dogs, and cat food is used with cats.

A chute 16 is positioned under the reservoir. The chute communicates between the reservoir 8 and the trough. Food is dispensed from the reservoir, and falls by gravity into the trough 18, where it is available to the animal.

In this embodiment, a dial 20 is positioned at an upper portion of the reservoir. The dial has multiple apertures 22, each of a different size or diameter. The dial allows the human user to select the amount of the food to be dispensed by increasing or decreasing the size of the aperture that communicates with the chute 16. Aperture size may be selected to accommodate the size of the individual food units that are present in the reservoir 8.

An aperture 22 of the plurality of apertures communicates with the chute 16 upon actuation of the food dispenser 4, when the food dispenser receives a signal from the actuator target. In one embodiment, the dial is rotated by a DC motor so that the selected aperture of the dial aligns with an aperture or opening to the chute, allowing food to drop through the aperture. The elapsed time of alignment of the apertures may be selected at a processor associated with the food dispenser to control the amount of food that is dispensed through the chute and into the trough. The selection of aperture size and time of exposure of the aperture to the chute opening allow control of the amount of food to be dispensed. In another embodiment, a solenoid may operate a door under the aperture of the dial and/or chute. The solenoid positions the door to block the aperture in a normal position, and upon actuation, the solenoid removes the door from blocking the aperture for a short, and preferable selectable, period of time to allow food to fall through the aperture.

Upon receiving an actuation signal, the food dispenser 4 dispenses a small amount of food into the trough 18. Since a goal of the invention is to encourage domesticated animal exercise but not encourage weight gain, only enough food to motivate the animal to seek the food is dispensed. The aperture of the dial and the elapsed time of the opening of the aperture are selected to preferably dispense only a small amount of food.

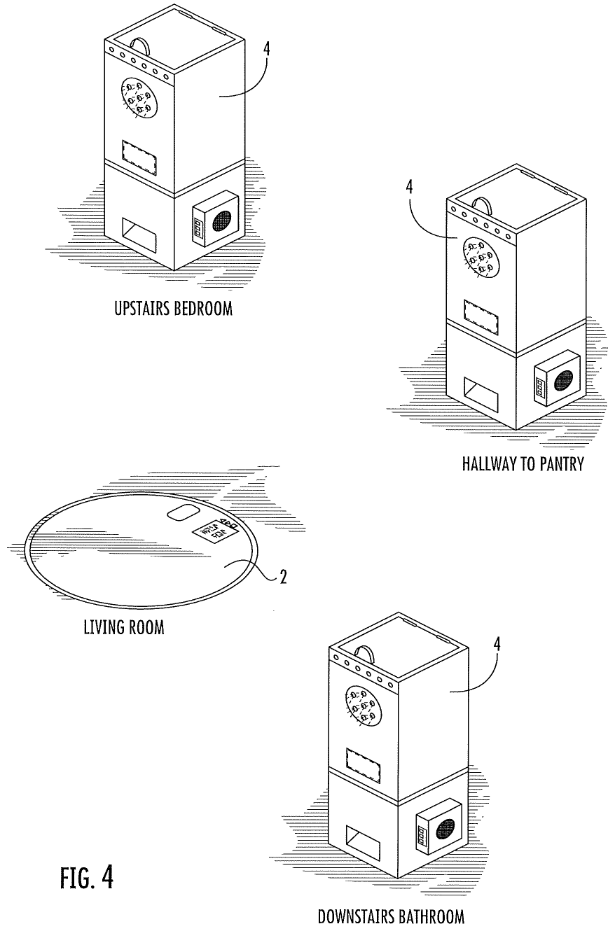

In a preferred embodiment, a plurality of food dispensers 4 are used in the system. The use of multiple spaced apart food dispensers, with only one food dispenser having food dispensed keeps the animal searching among the spaced apart food dispensers for food. FIG. 4 demonstrates a target 2 and three spaced apart food dispensers 4 positioned in multiple rooms in a house or building. The positioning of the food dispensers and targets of FIG. 4 are examples only. The positioning of the food dispensers is dependent on the size and configuration of the house or other building and the rooms in which the domesticated animal is allowed to visit or inhabit. In a small apartment, it may be possible to accommodate only one food dispenser, in which case the target and food dispenser should be positioned as far from each other as possible. In a larger house or other larger building, the animal may be required to search multiple rooms or multiple floors of the house or other building to find the food dispenser that has dispensed food.

In another embodiment, multiple spaced apart actuator targets are employed. In this embodiment, it is preferred that only one of multiple targets will actuate food dispensing by one of the dispensers at any particular time. This will cause the animal to hunt for the target that will provide food. The targets may be alternated each day or each time after the target causes food to be dispensed by a dispenser.

In one embodiment, the food dispenser 4 comprises a sensor 24 that detects when the food has been removed from the trough 18, most commonly after the animal has eaten the food. Actuation of the food dispenser may also actuate the sensor so that the animal stepping on the target again will not actuate the release of more food until the food is removed by the trough. An infrared beam may be emitted from a sender and a receiver across the trough, and if the beam is broken by the presence of food in the trough, the target will not be enabled to send a signal to that food dispenser or another a food dispenser. A device that detects additional weight in the trough from the presence of food could be used instead of a light beam. A timer may be used in the target's processor so that food cannot be dispensed by a food dispenser until a set amount of time has elapsed since a food dispenser was actuated, which may be the last food dispenser actuated, or another food dispenser.

The processor that controls the selection of the food dispenser, dispensing of food from the food dispenser, and audible and/or visual signals, and actuator target may be controlled from the food dispenser, or it may be controlled by a remote control or by an application for a computer or a cellular phone.

In another embodiment, an infrared beam is used as a target and sensor to actuate the device instead of the target or pad. In another embodiment, an infrared beam emitted within the trough or otherwise emitted from the food dispenser as a target to actuate the device by the animal rather than by the weight of the animal on a pad.

The food dispensers 4 may cause audible or visual signals to be emitted. The food dispenser may comprise lights 26 and/or a speaker 28 that emits a sound. Upon actuation and dispensing of food by the food dispenser, the audible signal of the food dispenser may sound for a period of time. The audible signal may be useful for systems having several food dispensers, so that the animal is given a clue regarding which dispenser has food available. The audible signal may also be useful in training the animal to use the system, as the animal learns to associate the audible signal with the availability of food. In one embodiment, the signal device may be deactivated after training so that the animal has to search for food among multiple food dispensers, resulting in more exercise for the animal. The visual signal may be useful for animals that are hearing deficient. The visual signal may be flashing lights, such as LEDs.

In one embodiment a ESP32-S3-WROOM-1-N4 MCU provides communication between the target and the individual food dispensers. Leveraging the ESP32-S3 mesh network, a pressure pad or other target wirelessly transmits signals to a designated dispenser, activating a motor of the dispenser for food dispensing. An ultrasonic sensor detects the animal's proximity to the feeder, triggering a signal for process reset. The device may provide for user control over LED/light settings, sound profiles, and volume levels. In the event of food depletion in any food dispenser, a photocell sensor coupled with a laser diode prompts a system-wide shut down, activating red LEDs across all food dispensers until refilling occurs, ensuring owner awareness. Furthermore, the network facilitates addition or removal of food dispensers, integrating them into the animal food dispensing system.

The device is particularly useful for domesticated mammals that are constrained within a house, apartment of other building as pets, such as cats and dogs. The device encourages movement and exercise by rewarding the animal with a small amount of food. “Small amount of food” means substantially less food in each dose of food dispensed by the dispenser than the animal would eat in a typical meal for the animal.

What is claimed:

1. An animal food dispensing system for exercising domesticated animals comprising:
an actuator target constructed and arranged to be actuated by a domesticated animal, the actuator target comprising a wireless transmitter;
an animal food dispenser spaced apart from the actuator target, the animal food dispenser comprising a wireless receiver constructed and arranged to receive a signal from the wireless transmitter;
wherein the signal transmitted from the wireless transmitter of the actuator target to the animal food dispenser actuates the food dispenser to release animal food from a reservoir of the food dispenser.

2. An animal food dispensing system for exercising domesticated animals as described in claim 1, comprising a plurality of food dispensers spaced apart from each other.

3. An animal food dispensing system for exercising domesticated animals as described in claim 1, comprising a plurality of food dispensers spaced apart from each other and a plurality of actuator targets spaced apart from each other.

4. An animal food dispensing system for exercising domesticated animals as described in claim 1, wherein the actuator target is constructed and arranged to be positioned on a floor of a building and the actuator target senses a presence of a domesticated animal to actuate the food dispenser.

5. An animal food dispensing system for exercising animals as described in claim 1, wherein the actuator target is constructed and arranged to be positioned on a floor of a building and the actuator target senses weight of a domesticated animal on the actuator target to actuate the food dispenser.

6. An animal food dispensing system for exercising domesticated animals as described in claim 1, comprising a plurality of food dispensers spaced apart from each other and a processor, wherein the processor enables one of the plurality of food dispensers to dispense food upon actuation of the actuator target.

7. An animal food dispensing system for exercising domesticated animals as described in claim 1, comprising a plurality of actuator targets spaced apart from each other and a processor, wherein the processor enables one of the plurality of actuator targets to cause the food dispenser to dispense food upon actuation of the one of the plurality of actuator targets.

8. An animal food dispensing system for exercising domesticated animals as described in claim 1, comprising a plurality of food dispensers spaced apart from each other and a processor, wherein the processor selectively enables one of the plurality of food dispensers to dispense food upon actuation of the actuator target on a rotating basis.

9. An animal food dispensing system for exercising domesticated animals as described in claim 1, comprising a plurality of actuator targets spaced apart from each other and a processor, wherein the processor selectively enables one of the plurality of actuator targets to cause the food dispenser to dispense food upon actuation of the one of the plurality of actuator targets on a rotating basis.

10. An animal food dispensing system for exercising domesticated animals as described in claim 1, comprising a plurality of food dispensers spaced apart from each other and a processor, wherein the processor enables one of the plurality of food dispensers to dispense food upon actuation of the actuator target and disables a remainder of the plurality of food dispensers, and wherein the processor enables the one of the plurality of food dispensers to emit an audible sound upon actuation of the actuator target.

11. An animal food dispensing system for exercising domesticated animals as described in claim 1, the food dispenser comprising an adjustable timer that controls an amount of time that food that is dispensed by the food dispenser.

12. An animal food dispensing system for exercising domesticated animals as described in claim 1, the food dispenser comprising a plurality of selectable apertures, with each aperture of the selectable apertures having a different area to allow an amount of food to be dispensed by the food dispenser that is defined by the area of a selected aperture.
